(19) United States
(12) Patent Application Publication
(10) Pub. No.: US 2006/0032068 A1
(43) Pub. Date: Feb. 16, 2006

(54) Layout and measurement graphic used in pattern construction and quilt design

(76) Inventors: Robert Niles Sherman, Lynnwood, WA (US); Steven Wayne Craft, Millcreek, WA (US)

Correspondence Address: Robert N. Sherman, 3-143rd St. SE, Lynnwood, WA, 98037, US

(21) Appl. No.: 10/916,677

(22) Filed: Aug. 12, 2004

(51) Int. Cl. G01B 3/14

(52) U.S. Cl. 33/566

(57) ABSTRACT

The graphical integration for layout and design which utilizes a series of rulers, lines, curves, and grids in the design and manufacturing of goods, including but not limited to quilts, clothes, upholstery, and other sewn items. The pattern can be applied to any desired surface required by the product being manufactured. The preferred material application is that used for ironing boards or ironing board covers.

### TECHNICAL FIELD

The present invention relates to the field of template and pattern construction in manufacturing and specifically to sewing activities such as quilt construction.

### BACKGROUND OF THE INVENTION

The present invention attempts to integrate the individual measuring devices used in pattern construction into a single surface. Rulers, protractors, and compasses are integrated in a user-friendly surface. Prior to the present invention, there were no patents or other devices found which incorporated the present inventions qualities.
1. U.S. Pat. No. 4,861,041 is the patent for the commercial material called Crypton, and no claims as to Crypton itself are made other than as a suitable material to which this invention may be applied.
2. Design Transfer Process: No claims are made as to any patents related to the design transfer process of the present invention.

### BRIEF DESCRIPTION OF THE DRAWINGS

Preferred embodiments of the invention are described below with reference to the following accompanying drawing.

FIG. 1 is a view of the printed pattern used in the construction of quilts or other material products.

### DETAILED DESCRIPTION OF THE PREFERRED EMBODIMENTS

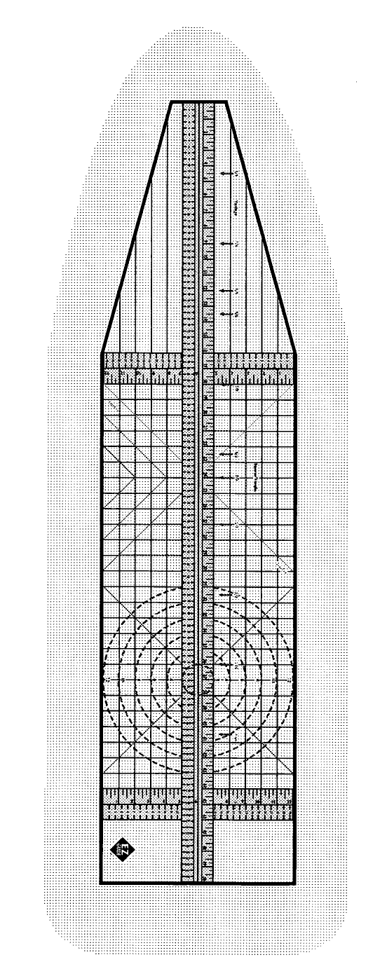

Referring in greater detail to the drawing in FIG. 1, a presently preferred form of the apparatus utilizes the integration of computer or traditionally drawn graphics (lines, curves, angles) on a single working surface which is wear, water, and heat resistant or resistive.

It is a preferred method that the pattern contained in FIG. 1 be transferred directly, indirectly, or through a sublimation process to heat and wear resistant material working surface. Such material may be cloth, metal, or other material suitable to the form of construction being undertaken.

For example, the use of the present invention in the profession of upholstery of vehicle or furniture would require the design to be transferred to a large flat metal or other firm working surface to a scale used in that industry.

Here, for illustration purposes only, the preferred material is a synthetic cloth called Crypton. The most common use for the present invention would be on ironing boards or covers. Many other commercially available fabrics and materials are available and suitable. Other suitable materials would include, but are not limited to, fabric, marble, steel, aluminum, and Teflon or other heat resistive plastic, to which the application can be made.

The preferred sublimation graphics design transfer process utilizes a large inkjet style printer to convert a computer generated graphic print of the invention design to the enlarged transfer medium in mirror image to that seen in FIG. 1. The design is then transferred to the working surface of the material through a sublimation process using a heat press application. The graphics are then embedded into the material permanently, or semi-permanently, through the sublimation process. The sublimation process is used most commonly with fabrics.

An alternative use of the present invention may be machined into the working surface of any metal or plastic by hand or computer controlled machining tools. The size of the final pattern shown in FIG. 1 may be made as large or small as required, and may be in standard or metric measurements.

Referring again in greater detail to FIG. 1, the present invention allows the user to layout infinite potential patterns or designs using a series of angles, curves, and lines contained in the pattern. The patterns may be a series of lines, curves, or angles, or combination thereof.

The rulers contained in the present inventions design are not limited to the present design in FIG. 1, but may contain one or more rulers as required by the construction project undertaken. The rulers may contain standard, metric, or a combination of any accepted standard construction measure.

The concentric circles allow the user to create consistent sized patterns of material to form an infinite number of designs. The circles overlay by the grid squares allow for inlay or overlay of project patterns to be created with precision. The numbers of circles contained in the present invention are not limited to those in FIG. 1.

The grid lines allow for the measure and design of a number of linear geographic shapes and patterns for use in the construction project as desired. The grid lines provide for multiple pieces of material to be aligned and a pattern design laid out with precision. Additionally the grid lines allow for the manipulation of material through folds and creases with accuracy.

The use of heat resistive material allows the use of heated irons to crease, fold, or heat glue material together using the lines, curves, grid, and rulers by working directly upon the present inventions surface.

1. A method of using a heat and water-resistant material containing rulers and geometric designs of angles, curves, and lines in layout and pattern design.
